(19) United States
(12) Patent Application Publication
(10) Pub. No.: US 2025/0298647 A1
(43) Pub. Date: Sep. 25, 2025

(54) VIRTUAL MACHINE TO CO-PROCESSOR PASSTHROUGH

(71) Applicant: QUALCOMM Incorporated, San Diego, CA (US)

(72) Inventors: Tony Truong, San Diego, CA (US); Bjorn Andersson, Austin, TX (US); Christopher Lew, San Diego, CA (US); Arun Prakash P P, Kozhikode (IN); Gaurang Parikh, San Diego, CA (US); Xiao Ye, Shanghai (CN); Lanxing Jiang, Shanghai (CN)

(21) Appl. No.: 18/610,108

(22) Filed: Mar. 19, 2024

(51) Int. Cl. G06F 9/455; G06F 9/54; G06F 11/07; G06F 13/28

(52) U.S. Cl. CPC G06F 9/4555; G06F 9/45558; G06F 9/544; G06F 11/0793; G06F 13/28; G06F 2009/45583

(57) ABSTRACT

Systems and methods for virtual machine to co-processor passthrough. In one embodiment, a system includes a host, a guest virtual machine (GVM), and co-processor. The host operates a hypervisor, the GVM communicates with the host via a paravirtualized interface, and the co-processor communicates with the host via a link layer transport. The host allocates a hardware transport resource for the GVM and the co-processor, sends an address of the hardware transport resource and an identifier of the co-processor to the GVM via the paravirtualized interface, and sends the address of the hardware transport resource and an identifier of the GVM to the co-processor via the link layer transport. The GVM and the co-processor establish a communication channel based on the address of the hardware transport resource and received identifiers, and transmit data over the communication channel directly between the GVM and the co-processor without intervention by the host.

### BACKGROUND

### Field

The present disclosure relates generally to computer virtualization, and more specifically, to communication between a virtual machine and co-processor.

### Background

Virtualization enables multiple guest virtual machines (GVMs) to run on the same physical hardware of a host system, each with its own isolated operating system (OS) and set of applications. Computing systems, including mobile devices and automotive platforms, are increasingly using GVMs to run applications in isolated environments. This allows for consolidation of multiple functions on a single hardware platform while providing a range of virtualization benefits in terms of resource optimization, flexibility, security, and ease of management.

Computing environments are also increasingly using co-processors to handle specialized functions or offload certain computations from the main processor. In a virtualized system, a GVM may offload a task to a co-processor to take advantage of its specialized processing capabilities. However, the host is responsible for routing data between the GVM and co-processor, handling interrupts, and managing the virtualized hardware resources. Having the host forward packets between the GVM and co-processor incurs latency and power overhead. Additionally, the host has visibility of the data it forwards which can introduce security risk in situations in which the host is not trusted.

### SUMMARY

According to an aspect, a virtualized computing system includes a host, a guest virtual machine (GVM), and co-processor. The host is configured to operate a hypervisor, the GVM is configured to communicate with the host via a paravirtualized interface, and the co-processor is configured to communicate with the host via a link layer transport. The host is configured to allocate a hardware transport resource for the GVM and the co-processor, to send an address of the hardware transport resource and an identifier of the co-processor to the GVM via the paravirtualized interface, and to send the address of the hardware transport resource and an identifier of the GVM to the co-processor via the link layer transport. The GVM and the co-processor are configured to establish a communication channel based on the address of the hardware transport resource and received identifiers, and to transmit data over the communication channel directly between the GVM and the co-processor without intervention by the host.

According to another aspect, a method is disclosed where the method includes allocating, with a host, a hardware transport resource for a guest virtual machine (GVM) and a co-processor; sending an address of the hardware transport resource and an identifier of the co-processor to the GVM via a paravirtualized interface; sending the address of the hardware transport resource and an identifier of the GVM to the co-processor via a link layer transport; establishing a communication channel based on the address of the hardware transport resource and received identifiers; and transmitting data over the communication channel directly between the GVM and the co-processor without intervention by the host.

According to yet another aspect, a non-transitory processor-readable medium is disclosed that comprises instructions for execution by a processor, the instructions comprising instructions to: allocate, with a host, a hardware transport resource for a guest virtual machine (GVM) and a co-processor; send an address of the hardware transport resource and an identifier of the co-processor to the GVM via a paravirtualized interface; send the address of the hardware transport resource and an identifier of the GVM to the co-processor via a link layer transport; establish a communication channel based on the address of the hardware transport resource and received identifiers; and transmit data over the communication channel directly between the GVM and the co-processor without intervention by the host.

### BRIEF DESCRIPTION OF THE DRAWINGS

FIG. 1 is a block diagram of a virtualized computing system in an example embodiment.

FIG. 2 is a flowchart illustrating a method of virtual machine to co-processor passthrough in an example embodiment.

FIG. 3 is a block diagram of a virtualized computing system in another example embodiment.

FIG. 4 is a block diagram illustrating a communication sequence between a host and GVM to setup a passthrough channel in an example embodiment.

FIG. 5 is a block diagram illustrating a communication sequence between a host and co-processor to setup a passthrough channel in an example embodiment.

FIG. 6 is a block diagram illustrating a communication sequence between a GVM and co-processor to setup a passthrough channel in an example embodiment.

FIG. 7 is a block diagram illustrating a communication sequence for re-establishing passthrough in the event of a crash of co-processor in an example embodiment.

FIG. 8 is a block diagram illustrating a communication sequence for re-establishing passthrough in the event of a crash of a GVM in an example embodiment.

FIG. 9 is a block diagram depicting physical components that may be utilized to realize the one or more aspects of the embodiments disclosed herein.

### DETAILED DESCRIPTION

The following modes, features or aspects, given by way of example only, are described in order to provide a more precise understanding of the subject matter of several embodiments.

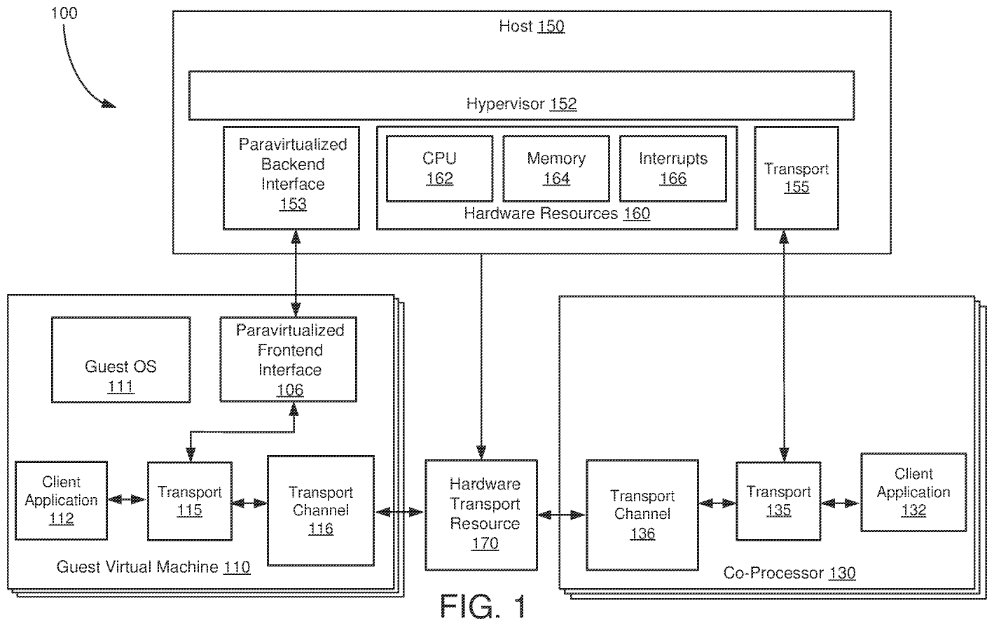

FIG. 1 is a block diagram of a virtualized computing system 100 in an example embodiment. Virtualized computing system 100 includes host 150, one or more guest virtual machines (GVMs) 110, and one or more co-processors 130. Host 150 is the physical computing environment that serves as the foundation for virtualization and includes hardware resources 160 such as central processing unit (CPU) 162, memory 164, and interrupts 166. Host 150 also includes a hypervisor 152 to abstract hardware resources 160 and create a virtualized layer that allows multiple GVMs 110 to run concurrently and share hardware resources 160 of host 150.

Co-processor 130 is a specialized processing component designed to assist the CPU 162, or main processor, in performing specific tasks. Host 150 and/or GVMs 110 may offload certain computational tasks to co-processors 130, freeing up resources of CPU 162 to handle other tasks. In one embodiment, virtualized computing system 100 comprises a system on chip (SoC) with multiple CPU cores and multiple co-processors 130 such as digital signal processors (DSPs) configured for signal processing tasks and/or graphics processing units (GPUs) configured for rendering graphics. A single SoC may include multiple DSPs dedicated for specific use cases or application spaces.

As an example, virtualized computing system 100 may comprise a SoC implemented as part of a mobile device or vehicle control system. In this context, co-processors 130 may comprise multiple DSPs including a compute DSP (cDSP) for computationally-intensive tasks (e.g., image processing, neural network-related calculations, and camera streaming), an audio DSP (aDSP) for lower-power processing of audio and voice data, a modem DSP (mDSP) for network communications, and/or a sensor DSP (sDSP) for processing sensor data. These examples illustrate the diversity of co-processors 130 and wide range of client applications 132, or software functions, they may execute to leverage specific processing capabilities.

Virtualized computing system 100 includes paravirtualization functionality to facilitate direct and efficient communication between host 150 and GVM 110. In contrast to a fully virtualized environment, paravirtualization enables a guest operating system (OS) 111 of GVM 110 to be aware of the virtualized environment and collaborate with hypervisor 152 or host 150 to reduce virtualization overhead and improve performance. Accordingly, Guest OS 111 includes a paravirtualized frontend interface 106 having or operating with device drivers that are modified to be aware of the virtualized environment. Paravirtualized backend interface 153 is the counterpart to the frontend and may include or operate with backend drivers that run in the hypervisor 152 or host 150, and which translate requests from the frontend into operations that can be executed on the physical devices.

One example of a paravirtualization framework is Virtio, which is an open standard that defines a protocol for communication between drivers and devices of different types. Using Virtio, a driver that interfaces with a paravirtualized device can be installed in Guest OS 111, providing an efficient abstraction mechanism for host 150 and a common set of input/output (I/O) virtualization drivers that make it possible to avoid the overhead of emulating real hardware in full virtualization. In one embodiment, paravirtualized interfaces 153/106 of host 150 and GVM 110 use Virtio to implement paravirtualization. Although Virtio is described herein, it is understood that other paravirtualized interfaces and paravirtualization techniques may be used.

In virtualized computing system 100, the combination of paravirtualized GVM(s) 110 and multi-processor architecture of co-processor(s) 130 running on the same physical platform of host 150 offers advantages related to security, resource efficiency, flexibility, performance, fault tolerance, and overall system manageability. However, in prior art implementations of this configuration, a client application 112 of GVM 110 communicates or offloads tasks to client application 132 of co-processor 130 via bridging through the host, which incurs latency and power overhead. That is, in a typical prior art arrangement, the host includes a client bridge through which all communication including setup commands, control commands, and data packets, are forwarded through the host. As such, all communication between GVM 110 and co-processor 130 traverses the paravirtualized interfaces between GVM 110 and host 150, and also traverses the communication mechanism between host 150 and co-processor 130.

To address the above issues, virtualized computing system 100 is enhanced to include a mechanism for host 150 to lend a hardware transport resource 170 to GVM 110 and co-processor 130. Advantageously, hardware transport resource 170 enables direct communication between GVM 110 and co-processor 130 without intervention by host 150. Since this allows data passthrough without any modification or handling from host 150, GVM 110 and co-processor 130 are able to communicate directly with reduced latency as well as reduced utilization of CPU 162 and therefore reduced power consumption. Moreover, data can be private between GVM 110 and co-processor 130, thus enhancing security for applications in which host 150 may not be trustworthy. Technical benefits are thus provided in terms of performance, power efficiency, and security.

In one embodiment, virtualized computing system 100 is enhanced with a link layer transport that enables the host 150 to lend hardware transport resource 170 for the direct exchange of data, messages, and requests between GVM 110 and co-processor 130. That is, each of host 150, GVM 110, and co-processor 130 includes or operates a respective transport 155/115/135. The transport 115/135 of GVM 110 and co-processor 130 establishes a transport channel 116/136 for direct communication without intervention by host 150.

In one embodiment, transport 155/115/135 comprises a shared memory transport to enable fast communications between entities running on host 150. Here, hardware transport resource 170 may comprise a shared direct memory access (DMA) buffer allocated by the host 150 for direct communication between GVM 110 and co-processor 130. In other embodiments, transport 155/115/135 may be based on alternative physical links such as those defined by universal serial bus (USB), universal asynchronous receiver/transmitter (UART), serial peripheral interface (SPI), Peripheral Component Interconnect (PCI), PCI express (PCIe), or any other transport. In the case that transport 155/115/135 is based on USB, for instance, hardware transport resource 170 may comprise USB hardware resources and communication interfaces.

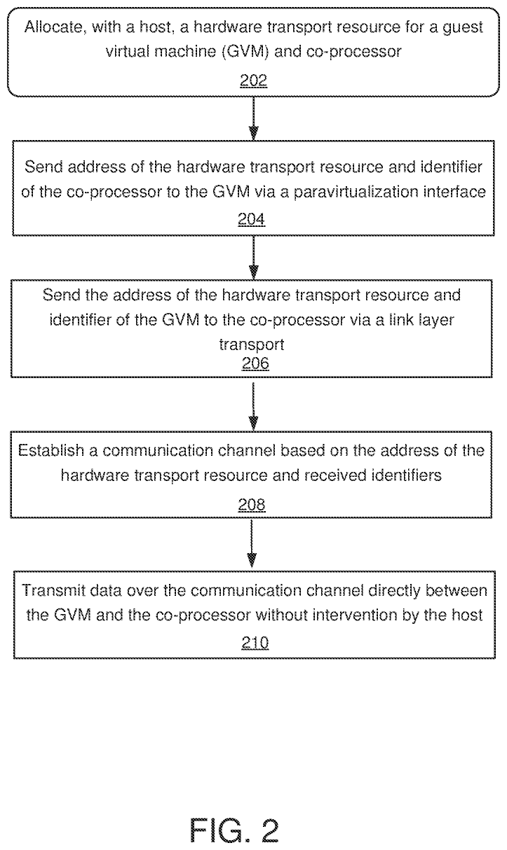

FIG. 2 is a flowchart illustrating a method of virtual machine to co-processor passthrough in an example embodiment. The steps of the method are described with reference to virtualized computing system 100 of FIG. 1, but those skilled in the art will appreciate that the method may be performed in other systems. The steps of the flowcharts described herein are not all inclusive, may include other steps not shown, and may be performed in an alternative order.

In step 202, host 150 allocates hardware transport resource 170 for GVM 110 and co-processor 130. In step 204, host 150 sends an address of hardware transport resource 170 and an identifier of co-processor 130 to GVM 110 via paravirtualized interface 153/106. In step 206, host 150 sends the address of hardware transport resource 170 and an identifier of GVM 110 to co-processor 130 via a link layer transport. In step 208, GVM 110 and co-processor 130 establish a communication channel based on the address of hardware transport resource 170 and received identifiers. And, in step 210, GVM 110 and co-processor 130 transmit data over the communication channel directly between one another without intervention by host 150.

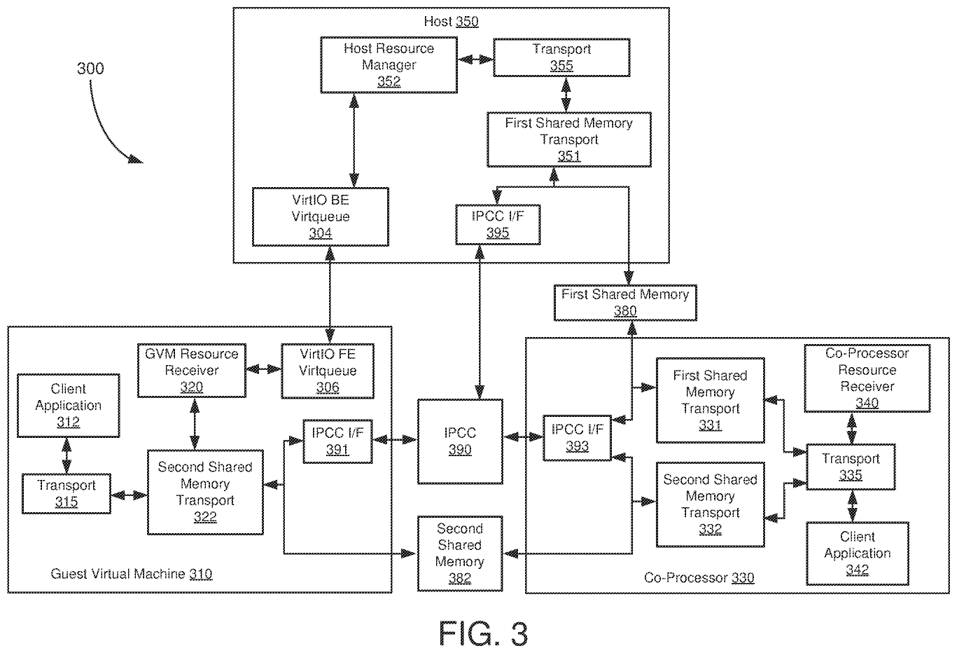

FIG. 3 is a block diagram of a virtualized computing system 300 in another example embodiment. Virtualized computing system 300 is an example of virtualized computing system 100 described above in FIG. 1 for which the link layer transport is a shared memory transport. In particular, host 350 implements an inter-process communication (IPC) mechanism using shared memory and interrupts. Host 350 includes a host resource manager 352 which is a component or module responsible for managing the resources of host 350. As described in greater detail below, host resource manager 352 is configured to allocate and donate a block or region of memory, designated as second shared memory 382, to be used for direct communication between the GVM 310 and co-processor 330 without intervention by host 350.

Host resource manager 352 is also configured to coordinate the setup of the communication channel between GVM 310 and co-processor 330. In particular, to facilitate communication with co-processor 330, host 350 includes a transport 355 and first shared memory transport 351. Transport 355 refers to a communication mechanism within host 350 that facilitates data exchange with other components. First shared memory transport 351 is a specific instance of the transport mechanism that uses shared memory for IPC communication with co-processor 330. In particular, host 350 and co-processor 330 use respective first shared memory transports 351/331 to access a first shared memory 380.

When host 350 writes data to first shared memory 380, first shared memory transport 331 of co-processor 330 is configured to read the data and relay it to co-processor resource receiver 340 via transport 335. Here again, transport 335 may encompass a broader communication mechanism of co-processor 330 whereas first shared memory transport 331 may encompass a more specific IPC mechanism to access first shared memory 380. Co-processor resource receiver 340 serves as an endpoint configured to process and respond to messages from host resource manager 352. In particular, in response to receiving an address of second shared memory 382 sent by host resource manager 352 via first shared memory 380, co-processor resource receiver 340 is configured to initialize a second shared memory transport 332 based on the received address. This may involve instructing or configuring transport 335 to setup pointers or indices of data structures, such as first-in first-out (FIFO) queues, at the received address of second shared memory 382.

Host 350 also includes a Virtio backend virtqueue 304 to communicate with corresponding Virtio frontend virtqueue 306 of GVM 310. Virtqueues implement a ring buffer as defined in the Virtio specification for which communication between a guest OS and host 350 can be realized through operations on queues without performing hardware emulation. For instance, when the Guest OS starts up, two data transfer queue endpoints are formed by drivers on the host side (i.e., backend) and GVM side (i.e. frontend). Virtio backend virtqueue 304 is part of the Virtio framework within host 350 that facilitates efficient communication with GVM 310. Virtio frontend virtqueue 306 is configured to receive data packets or control messages issued from host resource manager 352, and relay the data to GVM resource receiver 320 for processing.

GVM resource receiver 320 is a component or module within GVM 310 that handles the reception of resource information, such as memory addresses, from host resource manager 352. In particular, in response to receiving an address of second shared memory 382 sent by host resource manager 352 via Virtio interfaces, GVM resource receiver 320 is configured to initialize a second shared memory transport 322 based on the received address. Again, this may involve instructing or configuring transport 315 to setup pointers or indices of data structures at the received address of second shared memory 382. GVM resource receiver 320 therefore directs second shared memory 382 to establish a communication channel based on the received resource information.

Additionally, host 350 includes or operates with an inter-process communication controller (IPCC) 390 which is a hardware interrupt block configured to match interrupts between processors of virtualized computing system 300. Each of host 350, GVM 310, and co-processor 330 includes a respective IPCC interface 395/391/393 to match interrupts. Host resource manager 352 may provide a label or identifier to both GVM 110 and co-processor 330 to match interrupts, enabling them to coordinate operations and respond to events without involving host 350. Accordingly, second shared memory transports 322/332 of GVM 310 and co-processor 330, in conjunction with interrupt matching, enable client applications 312/342 running on GVM 310 and co-processor 330 to exchange data directly via second shared memory 382, bypassing host 350.

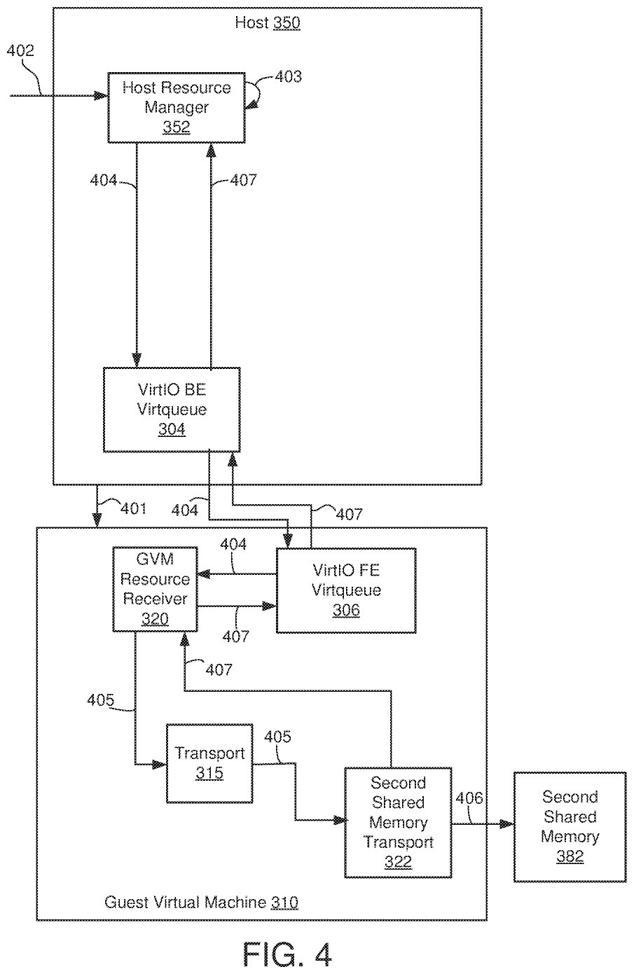

FIG. 4 is a block diagram illustrating a communication sequence between host 350 and GVM 310 to set up a passthrough channel in an example embodiment. In communication 401, host 350 loads and starts GVM 310. In communication 402, host resource manager 352 receives a callback indicating GVM 310 is up. Arrow 403 indicates host resource manager 352 allocating second shared memory 382 (not shown in FIG. 4). In communication 404, host resource manager 352 sends an address of second shared memory 382 to GVM resource receiver 320 via virtqueues 304/306. Additionally, host resource manager 352 may determine which co-processor 130 is to be linked with GVM 310, and send GVM resource receiver 320 a label or identifier of co-processor 130 so GVM 310 may determine which shared memory and which IPCC to use to communicate with co-processor 130.

In communication 405, in response to receiving the address, GVM resource receiver 320 is configured to register a second shared memory transport 322. That is, GVM resource receiver 320 calls transport 315 to start second shared memory transport 322. In communication 406, second shared memory transport 322 clears or zeros out second shared memory 382 and instantiates or sets up second shared memory 382 based on the link layer transport FIFO base addresses and sizes. In communication 407, second shared memory transport 322 generates and transmits an acknowledgement signal indicating the setup is done back to host 350 via GVM resource receiver 320, virtqueues 306/304, and host resource manager 352.

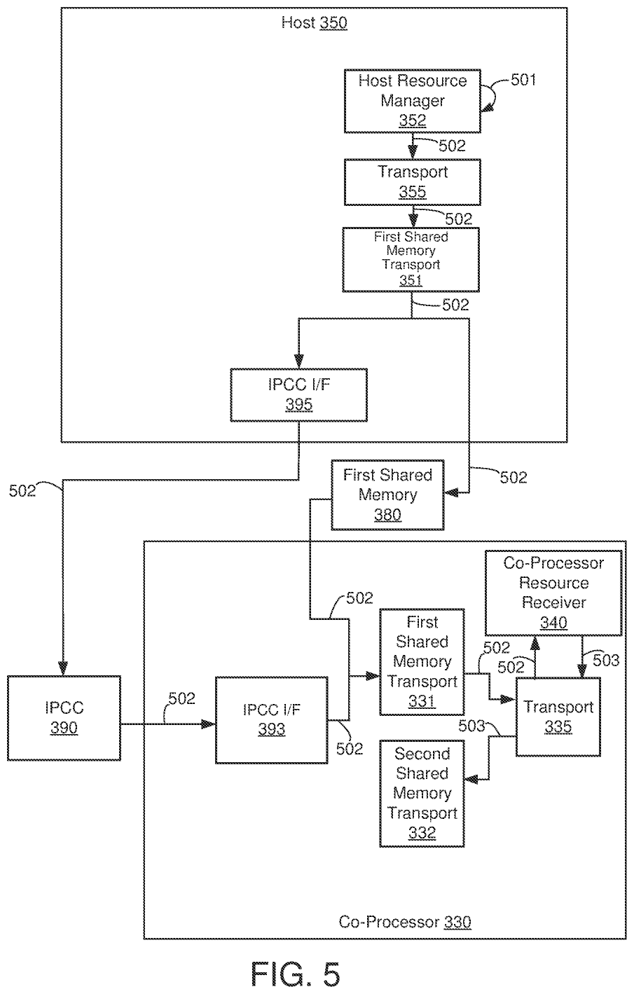

FIG. 5 is a block diagram illustrating a communication sequence between host 350 and co-processor 330 to setup a passthrough channel in an example embodiment. Arrow 501 indicates host resource manager 352 of host 350 links up with co-processor resource receiver 340 of co-processor 330. In particular, host resource manager 352 establishes communication with co-processor resource receiver 340 via respective first shared memory transports 351/331. Thereafter, host 350 may wait to proceed with subsequent co-processor setup steps until it receives the acknowledgement from GVM 310 that setup is completed (e.g., communication 407 described above). However, it is contemplated that in some embodiments host 350 may instead initiate setup of co-processor 330 prior to setup of GVM 310.

In communication 502, host resource manager 352 of host 350 sends an address of second shared memory 382 to co-processor resource receiver 340 via first shared memory transports 351/331. In particular, host resource manager 352 writes the address of second shared memory 382 to first shared memory 380 via first shared memory transport 351. Host resource manager 352 may also determine which GVM 310 is to be linked with co-processor 330, and send co-processor 330 a label or identifier of GVM 310 so co-processor 330 may determine which shared memory and which IPCC to use to communicate with GVM 310. First shared memory transport 331 of co-processor 330 reads the address from first shared memory 380 and provides it to co-processor resource receiver 340 via transport 335. In communication 503, in response to receiving the address, co-processor resource receiver 340 is configured to register a second shared memory transport 332. That is, co-processor resource receiver 340 calls transport 335 to start second shared memory transport 332.

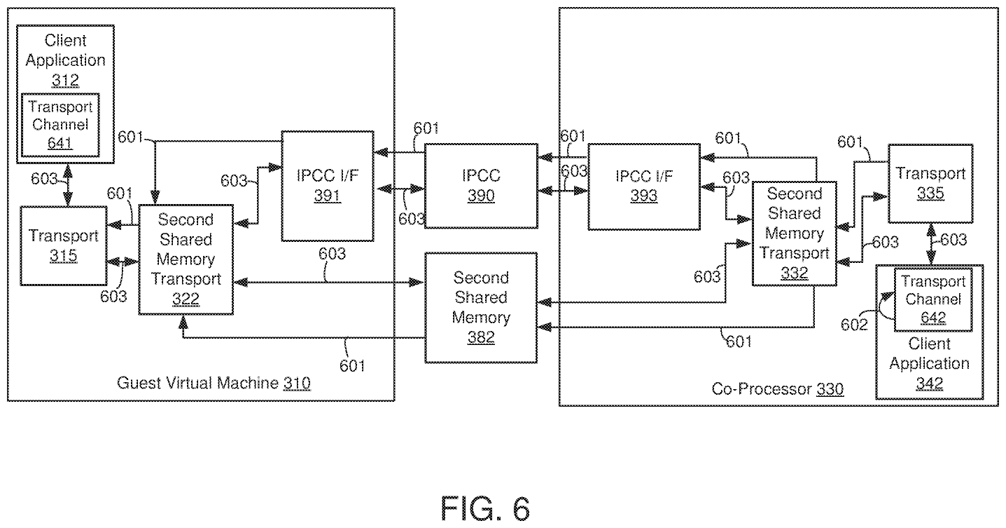

FIG. 6 is a block diagram illustrating a communication sequence between GVM 310 and co-processor 330 to setup a passthrough channel in an example embodiment. In communication 601, transport 335 of co-processor 330 starts a link connection with transport 315 of GVM 310, or vice versa. Arrow 602 indicates a transport channel 642 of co-processor 330 establishes the link connection and calls transport 335 open. In communication 603, co-processor 330 and GVM 310 establish communication over respective transport channels 642/641 using second shared memory 382 and interrupts (e.g., IPCC 390). The process of communications 601 and 603 are similar and may be combined for generalization. After the setup communications described with respect to FIGS. 4-6, GVM 310 and co-processor 330 are configured to transmit and receive data directly between one another using shared memory and interrupts without handling of data by host 350. It will be appreciated, however, that GVM 310 and co-processor 330 may in some embodiments establish a direct communication link using a hardware transport resource other than shared memory and interrupts.

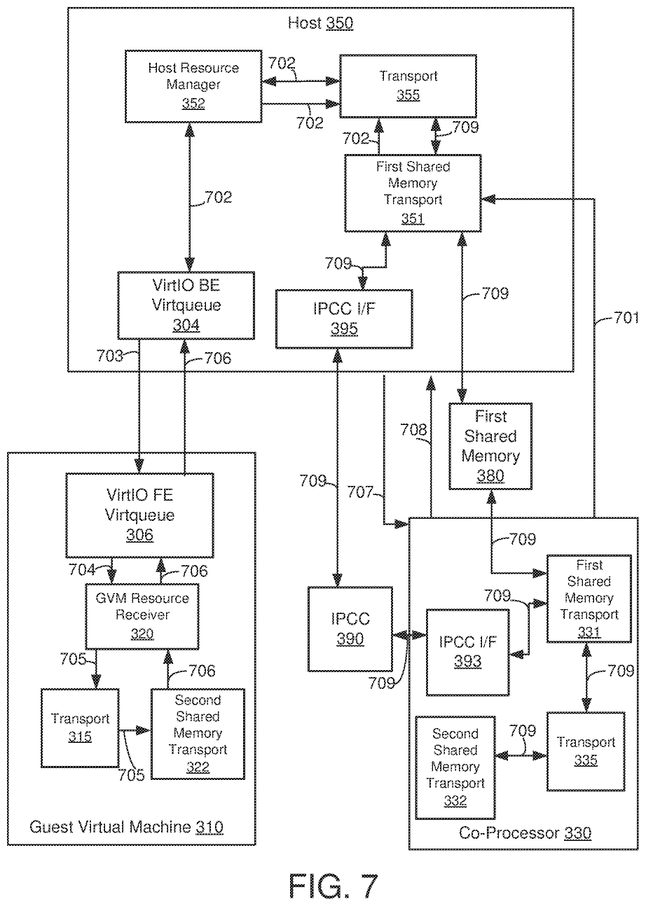

FIG. 7 is a block diagram illustrating a communication sequence for re-establishing passthrough in the event of a crash of co-processor 330 in an example embodiment. In communication 701, co-processor 330 signals host 350 of crash event. The crash signal may comprise an interrupt (e.g., ERR_FATAL interrupt) or be sent via a watchdog hardware interrupt request (IRQ) sent to first shared memory transport 351 of host 350 to detect the crash event. In communication 702, first shared memory transport 351 sends a signal to Virtio backend virtqueue 304 indicating a subsystem reset (SSR) of co-processor 130. This communication may be implemented using a shared memory point to point (SMP2P) protocol or an SSR service registration sent via host resource manager 352. That is, host resource manager 352 may register for notifications that one of co-processors 330 has crashed and signal to Virtio backend virtqueue 304 that co-processor 330 has crashed.

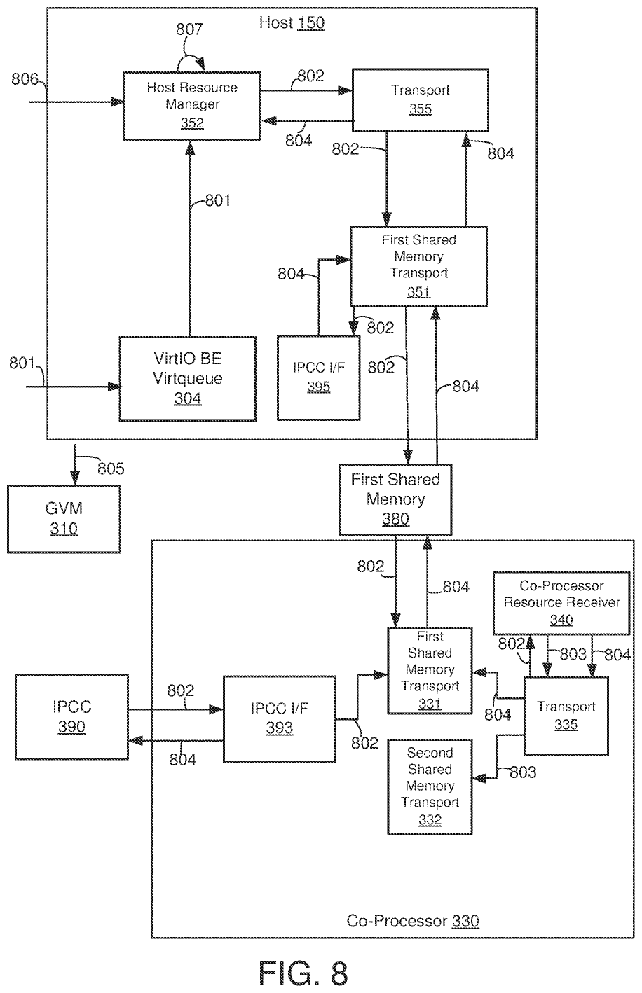

In communication 703, Virtio backend virtqueue 304 signals (e.g., via virtual general interrupt controller (GIC)) to Virtio frontend virtqueue 306 an indication that co-processor 330 has crashed and waits for an acknowledgement. In communication 704, Virtio frontend virtqueue 306 forwards the indication to GVM resource receiver 320. In communication 705, GVM resource receiver 320 initiates a transport unregister for second shared memory transport 322 to release second shared memory 382 (not shown in FIG. 8). In communication 706, second shared memory transport 322 sends an acknowledgement to Virtio backend virtqueue 304 vai GVM resource receiver 320. In step 707, host 350 resets co-processor 330. In communication 708, co-processor 330 transmits a signal that it is up. In communication 709, host resource manager 352 establishes a new connection with co-processor 330 (e.g., to co-processor resource receiver 340, not shown in FIG. 7) via a first transport mechanism, and the first transport mechanism may be used to re-establish a second transport mechanism between co-processor 330 and GVM 310, similar to that previously discussed.

FIG. 8 is a block diagram illustrating a communication sequence for re-establishing passthrough in the event of a crash of GVM 310 in an example embodiment. In communication 801, Virtio backend virtqueue 304 of host 350 is notified via a framework that GVM 310 is going through a reset (e.g., via virtual machine monitor (VMM) service or a virtual device driver (vdev)). This communication is forwarded to host resource manager 352 to detect the crash event. In communication 802, host resource manager 352 sends a message indicating the reset to co-processor resource receiver 340 via first shared memory 380 and IPCC 390; and waits for an acknowledgement to return.

In communication 803, co-processor resource receiver 340 calls second shared memory transport 332 to unregister to stop client application 342 from accessing second shared memory 382 (not shown in FIG. 8). In communication 804, co-processor resource receiver 340 returns an acknowledgement signal to host resource manager 352. In communication 805, host 350 allows GVM 310 to reset. In communication 806, host resource manager 35 is notified GVM 310 is up. And, as indicated by arrow 807, host 350 and/or first host resource manager 352 may initiate subsequent communications for setting up passthrough as previously described with respect to FIG. 4.

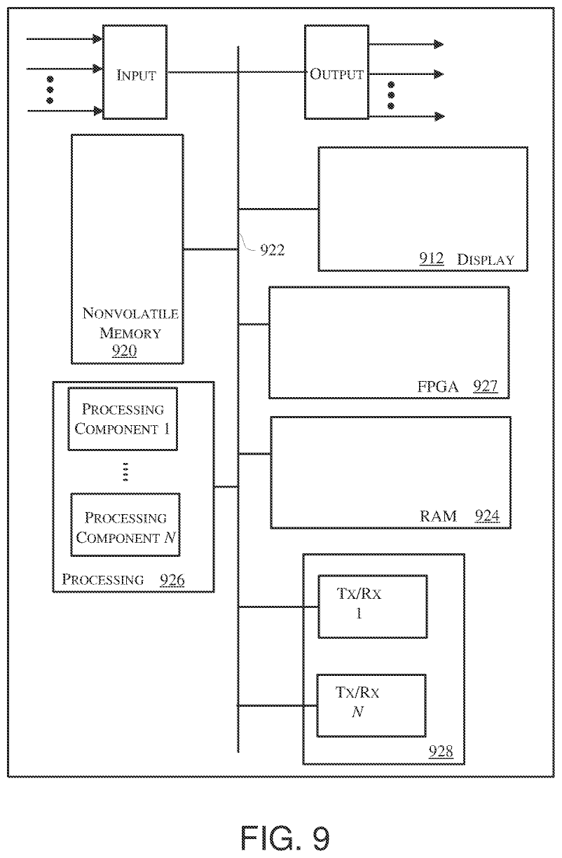

FIG. 9 is a block diagram depicting physical components that may be utilized to realize the one or more aspects of the embodiments disclosed herein. As shown, in this embodiment a display portion 912 and nonvolatile memory 920 are coupled to a bus 922 that is also coupled to random access memory (“RAM”) 924, a processing portion (which includes N processors) 926, a field programmable gate array (FPGA) 927, and a transceiver component 928 that includes N transceivers. Although the components depicted in FIG. 9 represent physical components, FIG. 9 is not intended to be a detailed hardware diagram; thus many of the components depicted in FIG. 9 may be realized by common constructs or distributed among additional physical components. Moreover, it is contemplated that other existing and yet-to-be developed physical components and architectures may be utilized to implement the functional components described with reference to FIG. 9.

This display portion 912 may be utilized to realize a portion of a display system and it generally operates to provide a user interface for a user. The display may be realized, for example, by an LCD or AMOLED display, and in several implementations, the display is realized by a touchscreen display. In general, the nonvolatile memory 920 is non-transitory memory that functions to store (e.g., persistently store) data and processor executable code (including executable code that is associated with effectuating the methods described herein). In some embodiments for example, the nonvolatile memory 920 includes bootloader code, operating system code, file system code, and non-transitory processor-executable code to facilitate the execution of the methods described herein including the methods described with reference to FIG. 2.

In many implementations, the nonvolatile memory 920 is realized by flash memory (e.g., NAND or ONENAND memory), but it is contemplated that other memory types may be utilized as well. Although it may be possible to execute the code from the nonvolatile memory 920, the executable code in the nonvolatile memory is typically loaded into RAM 924 and executed by one or more of the N processing components in the processing portion 926.

The N processors 926 in connection with RAM 924 generally operate to execute the instructions stored in nonvolatile memory 920 to enable aspects described herein. For example, a non-transitory processor-readable medium with instructions to effectuate the method described with reference to FIG. 2 may be persistently stored in nonvolatile memory 920 and executed by the N processing components in connection with RAM 924. As one of ordinarily skill in the art will appreciate, in addition to several CPUs, the processors 926 may include a video processor, digital signal processor (DSP), graphics processing unit (GPU), and other processing components.

In addition, or in the alternative, the FPGA 927 may be configured to effectuate one or more aspects of the methodologies described herein (e.g., the method described with reference to FIG. 2). For example, non-transitory FPGA-configuration-instructions may be persistently stored in nonvolatile memory 920 and accessed by the FPGA 927 (e.g., during boot up) to configure the FPGA 927 to effectuate the functions described herein.

The depicted transceiver component 928 includes N transceiver chains, which may be used for communicating with external devices via wireless or wireline networks. Each of the N transceiver chains may represent a transceiver associated with a particular communication scheme (e.g., WiFi, CDMA, Bluetooth, NFC, etc.). The transceiver chains may be utilized, for example, to request and receive webpages and webpage objects that are processed (e.g., parsed and rendered).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A system comprising:
a host configured to operate a hypervisor;
a guest virtual machine (GVM) configured to communicate with the host via a paravirtualized interface; and
a co-processor configured to communicate with the host via a link layer transport;
wherein the host is configured to allocate a hardware transport resource for the GVM and the co-processor, to send an address of the hardware transport resource and an identifier of the co-processor to the GVM via the paravirtualized interface, and to send the address of the hardware transport resource and an identifier of the GVM to the co-processor via the link layer transport; and
wherein the GVM and the co-processor are configured to establish a communication channel based on the address of the hardware transport resource and received identifiers, and to transmit data over the communication channel directly between the GVM and the co-processor without intervention by the host.

2. The system of claim 1, wherein:
the GVM is configured to communicate with the host via a Virtio interface;
the co-processor is configured to communicate with the host via a first shared memory transport; and
the GVM and the co-processor are configured, in response to receiving the identifiers, to establish the communication channel based on respective second shared memory transports.

3. The system of claim 2, wherein:
the GVM and the co-processor include a respective second shared memory transport to communicate via shared memory and interrupt matching.

4. The system of claim 2, wherein:
the host is configured to allocate a shared direct memory access (DMA) buffer for the GVM and the co-processor;
the GVM includes a second shared memory transport configured, in response to receiving an address of the shared DMA buffer, to establish the communication channel by clearing the shared DMA buffer based on the address, and instantiating a first-in first-out (FIFO) queue at the address; and
the co-processor includes a second shared memory transport configured, in response to receiving the address of the shared DMA buffer, to connect to the FIFO queue based on the address, wherein the FIFO queue serves as the communication channel between the GVM and the co-processor.

5. The system of claim 4, wherein:
the communication channel establishes a link between a first client application operating on the GVM and a second client application operating on the co-processor.

6. The system of claim 4, wherein:
the host is configured to detect a crash event of the co-processor, to direct the GVM to release the shared DMA buffer, and in response to receiving an acknowledgement from the GVM, to direct the second shared memory transport of the co-processor to re-establish the communication channel.

7. The system of claim 4, wherein:
the host is configured to detect a crash event of the GVM, to direct the co-processor to stop the second shared memory transport from accessing the shared DMA buffer, and in response to receiving an indication that the GVM is up, to direct the GVM to re-establish the communication channel.

8. A method comprising:
allocating, with a host, a hardware transport resource for a guest virtual machine (GVM) and a co-processor;
sending an address of the hardware transport resource and an identifier of the co-processor to the GVM via a paravirtualized interface;
sending the address of the hardware transport resource and an identifier of the GVM to the co-processor via a link layer transport;
establishing a communication channel based on the address of the hardware transport resource and received identifiers; and
transmitting data over the communication channel directly between the GVM and the co-processor without intervention by the host.

9. The method of claim 8, wherein:
sending the address from the host to the GVM via a Virtio interface;
sending the address from the host to the co-processor via a first shared memory transport; and
in response to receiving the identifiers at the GVM and the co-processor, establishing the communication channel based on respective second shared memory transports of the GVM and the co-processor.

10. The method of claim 9, wherein:
the respective second shared memory transports communicate via shared memory and interrupt matching.

11. The method of claim 9, further comprising:
allocating, with the host, a shared direct memory access (DMA) buffer for the GVM and the co-processor;
in response to receiving an address of the shared DMA buffer at the GVM, establishing with a second shared memory transport of the GVM, the communication channel by clearing the shared DMA buffer based on the address, and instantiating a first-in first-out (FIFO) queue at the address; and
in response to receiving the address of the shared DMA buffer at the co-processor, connecting with a second shared memory transport of the co-processor, to the FIFO queue based on the address, wherein the FIFO queue serves as the communication channel between the GVM and the co-processor.

12. The method of claim 11, wherein:
the communication channel establishes a link between a first client application operating on the GVM and a second client application operating on the co-processor.

13. The method of claim 11, further comprising:
detecting a crash event of the co-processor;
directing the GVM to release the shared DMA buffer; and
in response to receiving an acknowledgement from the GVM, directing the second shared memory transport of the co-processor to re-establish the communication channel.

14. A non-transitory processor-readable medium comprising instructions for execution by a processor, the instructions comprising instructions to:
allocate, with a host, a hardware transport resource for a guest virtual machine (GVM) and a co-processor;
send an address of the hardware transport resource and an identifier of the co-processor to the GVM via a paravirtualized interface;
send the address of the hardware transport resource and an identifier of the GVM to the co-processor via a link layer transport;
establish a communication channel based on the address of the hardware transport resource and received identifiers; and
transmit data over the communication channel directly between the GVM and the co-processor without intervention by the host.

15. The non-transitory processor-readable medium of claim 14, wherein the instructions comprise instructions to:
send the address from the host to the GVM via a Virtio interface;
send the address from the host to the co-processor via a first shared memory transport; and
in response to receiving the identifiers at the GVM and the co-processor, establish the communication channel based on respective second shared memory transports of the GVM and the co-processor.

16. The non-transitory processor-readable medium of claim 15, wherein:
the respective second shared memory transports communicate via shared memory and interrupt matching.

17. The non-transitory processor-readable medium of claim 15, wherein the instructions comprise instructions to:
allocate, with the host, a shared direct memory access (DMA) buffer for the GVM and the co-processor;
in response to receiving an address of the shared DMA buffer at the GVM, establish with a second shared memory transport of the GVM, the communication channel by clearing the shared DMA buffer based on the address, and instantiating a first-in first-out (FIFO) queue at the address; and
in response to receiving the address of the shared DMA buffer at the co-processor, connect with a second shared memory transport of the co-processor, to the FIFO queue based on the address, wherein the FIFO queue serves as the communication channel between the GVM and the co-processor.

18. The non-transitory processor-readable medium of claim 17, wherein:
the communication channel establishes a link between a first client application operating on the GVM and a second client application operating on the co-processor.

19. The non-transitory processor-readable medium of claim 17, the instructions comprise instructions to:
detect a crash event of the co-processor;
direct the GVM to release the shared DMA buffer; and
in response to receiving an acknowledgement from the GVM, direct the second shared memory transport of the co-processor to re-establish the communication channel.

20. The non-transitory processor-readable medium of claim 17, the instructions comprise instructions to:
detect a crash event of the GVM;
direct the co-processor to stop the second shared memory transport from accessing the shared DMA buffer; and
in response to receiving an indication that the GVM is up, direct the GVM to re-establish the communication channel.
